(19) United States
(12) Patent Application Publication
(10) Pub. No.: US 2026/0080087 A1
(43) Pub. Date: Mar. 19, 2026

(54) Agent Transition Allowability Based on Current Privilege Level

(71) Applicant: Apple Inc., Cupertino, CA (US)

(72) Inventors: Jeff Gonion, Campbell, CA (US); Bernard J. Semeria, Palo Alto, CA (US); Alexander Donald Charles Chadwick, Cambridge (GB)

(21) Appl. No.: 19/324,679

(22) Filed: Sep. 10, 2025

Related U.S. Application Data
(60) Provisional application No. 63/696,076, filed on Sep. 18, 2024.

(51) Int. Cl. G06F 21/62

(52) U.S. Cl. CPC G06F 21/6218

(57) ABSTRACT

A processor circuit is configured to receive, while a current software agent is executing in a current execution mode, an indication of an execution mode transition that attempts to change an execution mode index from a current value indicative of the current execution mode to a new value indicative of a new execution mode. The processor circuit is configured to access, based on the current privilege level, particular execution mode transition information in a storage circuit to determine whether the execution mode transition is allowed. The processor circuit is configured to determine, based on particular execution mode transition information, whether to update the current value indicative of the current execution mode. The processor is further configured to update the current value indicative of the current execution mode based on a determination that the execution mode transition is permitted.

The present application claims priority to U.S. Provisional App. No. 63/696,076, entitled “Agent Transition Allowability Based on Current Privilege Level,” filed Sep. 18, 2024, the disclosure of which is incorporated by reference herein in its entirety.

### BACKGROUND

### Technical Field

This disclosure relates generally to computer processors, and more specifically to the use of permissions in computer processors.

### Description of the Related Art

Computer processors, also known as central processing units (CPUs), are the core components of computing devices that perform a wide range of computational tasks. These circuits (referred to as processor circuits) are responsible for executing instructions within the processor circuit's instruction set architecture (ISA), managing data, and controlling the overall operation of a computer system. Processor circuits are found in various devices, including personal computers, laptops, smartphones, servers, and embedded systems, powering the functionality and performance of these devices.

Some instructions in a processor circuit's ISA may be reserved for execution at a specific privilege level, which is typically determined at the time the instruction is executed. Most software executes at a relatively less privileged level of privilege (e.g., an unprivileged privilege level), preventing the software from accessing and/or updating critical processor state and other protected resources (thus helping ensure security in the system). In many cases, such software cannot execute instructions that are restricted to more privileged levels of privilege. Parts of the operating system that do access/change such state, on the other hand, may execute at more privileged levels (e.g., a privileged privilege level). The number of privilege levels and the instructions that can be executed at each privilege level varies from ISA to ISA.

Permissions play a crucial role in the functioning of processor circuits. A processor circuit's ability to execute tasks efficiently and securely relies on the concept of permissions. Permissions determine what actions and resources are accessible to different components within a system, ensuring the integrity, confidentiality, and availability of data and functionalities. By enforcing permissions, processor circuits ensure that only authorized entities can perform specific operations or access sensitive data, protecting against unauthorized or malicious activities.

Current computer processor circuits typically execute with address translation enabled: the addresses of instructions fetched by the processors and the data addresses accessed by memory-accessing instructions such as loads and stores are virtual addresses, which are then mapped to physical addresses that actually identify the physical memory locations storing the instructions and data. The mapping is performed at a specified granularity, commonly referred to as a “page.” A set of software-managed page tables define the virtual-to-physical address mappings at the page granularity. A virtual address is used to locate an entry in the page table with the physical page number for the page. The least significant bits of the virtual addresses define an offset within a page and are not translated. After translation, the remaining virtual address bits are replaced by a physical page number. Address translation of the sort provided by a page table provides isolation between different programs running on the same system. It also permits the use of a virtual address space larger than the physical address space by paging data in and out of backing storage of various types (e.g., non-volatile storage, disk drives, solid state drives, etc.). In addition, address translation allows for memory protection at the page level of granularity.

### BRIEF DESCRIPTION OF THE DRAWINGS

FIG. 1 is a block diagram of one embodiment of an apparatus that includes a processor circuit configured to perform an execution mode transition by attempting to update a value of an execution mode index.

FIG. 2 is a block diagram of one embodiment of an execution mode index management circuit configured to access a storage circuit configured to store transition information.

FIG. 3 is a block diagram illustrating two possible configurations of a storage circuit configured to store execution mode transition information.

FIG. 4 is a block diagram of one organization of a portion of a two-dimensional storage circuit configured to store execution mode transition information that corresponds to a particular privilege level.

FIG. 5 is a block diagram illustrating example instruction formats for execution mode transition instructions.

FIG. 6 is a block diagram of one embodiment of a permissions circuit.

FIG. 7 is a flow diagram of one embodiment of a method for performing an execution mode transition.

FIG. 8 is a block diagram of one embodiment of a processor circuit that may be implemented on one or more integrated circuits (ICs).

### DETAILED DESCRIPTION

An application executing on a processor circuit may contain code from many disparate origins, including shared libraries, malloc function calls, a dynamic linker/loader, application logic, user interface (UI) code, etc. Such code may execute in some instances as separate threads of the application. For runtime-compiled or just-in-time (JIT) scenarios, code to be executed may come from input code, a JIT compiler, a JIT validator, or a JIT output region. For a kernel of an operating system, this code may include memory management code, other kernel code, and kernel-mode drivers.

For reasons of security, it is frequently desired to isolate or “sandbox” these disparate components by enforcing certain restrictions on their operation and interaction. For example, it may be desired that only malloc code should be able to read/write malloc metadata; only JIT validator code can write to the JIT output region; shared libraries can only read/write the heap regions of the software component that called them, etc.

This disclosure describes extensions relating to permissions that provide code isolation properties that are compatible with process isolation, but without the overhead of context switches and while still permitting use of a shared address space. The present disclosure relates to so-called overlay permissions (i.e., permissions that overlay a set of base or default permissions) that may include both spatial and temporal controls. For example, both data and code may be identified spatially, such as on a per-page granularity, according to the translation of the virtual address of that data or code. This allows enforcement of permissions for what code can read/write what data, branch/return to what other code, and execute which instructions/system registers.

A first identifier, referred to herein as an execution mode index, can also be used to identify a current execution mode for code (i.e., a software agent) that is being executed. Accordingly, the source of a memory access may be qualified with both the first identifier and another identifier (e.g., a second identifier based on the current value of the program counter (PC) being executed). Permissions for a given region of virtual memory may thus be based not only on the location of the instructions that are executing, but also on the current execution mode.

As a temporal control, the value of the execution mode index (which may also be referred to as TIndex, or temporal index, which is an execution mode identifier) may be changed from time to time as the software agent that is executing changes execution mode (e.g., because of a control flow instruction such as a call or return). This change may be effectuated in some implementations via execution of an execution mode transition instruction within the ISA of a processor circuit. Such instructions may be executed at different privilege levels of a processor circuit that is configured to execute instructions at a plurality of privilege levels.

Because a change in the execution mode index may affect permissions, a check can be performed to determine whether a transition from one particular execution mode to another is allowable. The present inventors have recognized that it would be desirable for the allowability of a given transition to a new execution mode to vary depending on the current privilege level. Accordingly, the present disclosure describes a paradigm in which separate execution mode transition information for different privilege levels (e.g., both privileged and unprivileged privilege levels) is stored in a storage circuit configured to store execution mode transition information. The execution mode transition information indicates, for a specified execution mode transition and the current privilege level, whether a particular execution mode transition is allowed. The execution mode transition information thus allows a given transition to have different indications of allowability at different privilege levels.

The present disclosure also describes that, in some embodiments, an ISA of a processor circuit may have different types of instructions for different “directionalities” of execution mode transitions. A “forward” execution mode transition is an execution mode transition that is associated with a control flow change in which a new portion of code is being called (e.g., a call, which is used to initiate the beginning of a new function or subroutine or different thread), while a “backward” execution mode transition is an execution mode transition that is associated with a control flow change in which some portion of code is completing and control is being returned to a calling block of code (e.g., a return). Note that the execution mode transition is not the control flow change itself, but is instead performed in association with a control flow change. In some implementations, different execution mode transition information may be used for a forward execution mode transition instruction versus a backward execution mode transition instruction, thus permitting the allowability to vary between the two types of instructions. Permitting the allowability of execution mode transitions to vary by privilege level (and, in some cases, transition directionality) aids in allowing instructions to have different permissions for the same portion of virtual memory. In this manner, more robust controls can be provided in scenarios involving different threads operating with shared virtual memory.

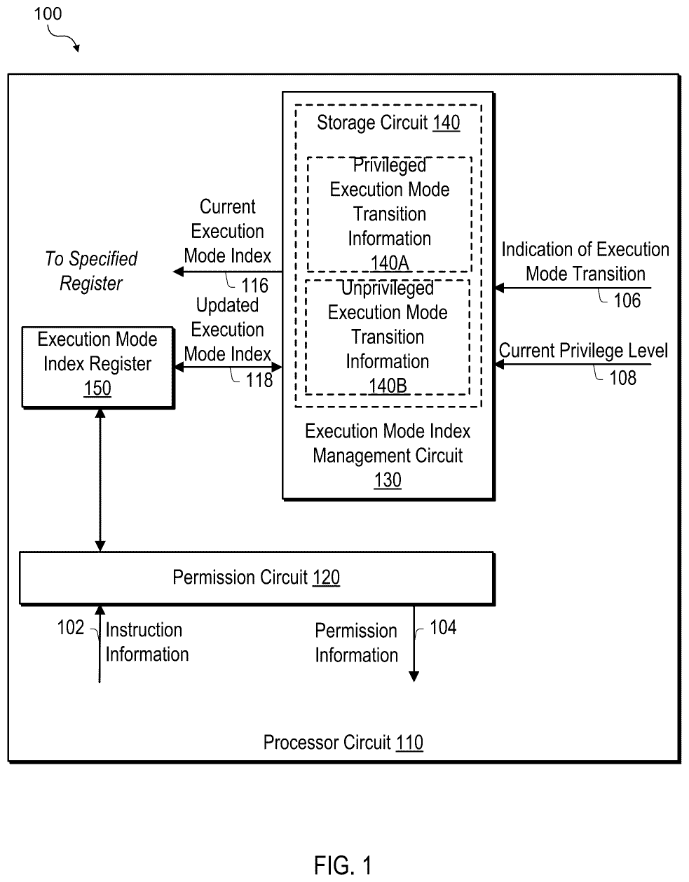

FIG. 1 is a block diagram of one embodiment of an apparatus 100 that includes a processor circuit 110 that is configured to perform an execution mode transition by attempting to update a value of an execution mode index. As shown, processor circuit 110 includes execution mode index management circuit 130, execution mode index register 150, and permission circuit 120. Processor circuit 110 is a circuit that is configured to act as a central processing unit (CPU) within apparatus 100, which may be a computer system, or portion thereof. In some embodiments, execution mode index management circuit 130 and permission circuit 120 may be located on different integrated circuits (ICs).

Processor circuit 110 is configured to execute instructions within its ISA at multiple different privilege levels. This plurality of privilege levels can include one or more privilege levels that are privileged (e.g., for certain portions of an operating system) and one or more privilege levels that are unprivileged (e.g., for user space applications). Processor circuit 110 may maintain state information (e.g., a register) indicating a current privilege level 108 for instructions that are being executed.

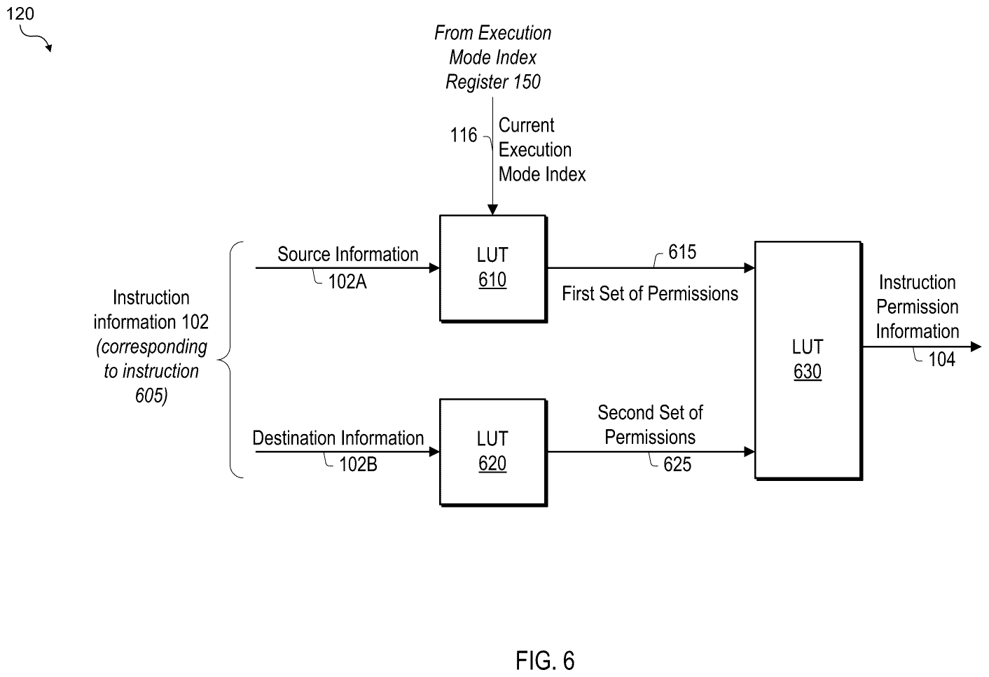

Execution mode index register 150, in the depicted embodiment, is configured to store a value—the execution mode index—that is indicative of an execution mode of a software agent currently executing on processor circuit 110. A software agent is a broad term intended to refer to any type of code, including a thread of a process, or a subcomponent of a particular process or thread. The current value stored in execution mode index register 150 may be used by permission circuit 120 along with instruction information 102 to compute instruction permission information 104 (e.g., read/write/execute permissions) for instructions being executed by processor circuit 110. Permission circuit 120 may be part of a memory management unit (MMU) circuit in one embodiment. The operation of one embodiment of permission circuit 120 will be described further with respect to FIG. 6.

Execution mode index management circuit 130 is configured, in response to receiving an execution mode transition indication 106, to attempt an update to the current value of execution mode index register 150. Note that there are constraints on the updating of execution mode index register 150. For a given execution mode transition indicated by 106 (which specifies a new execution mode index), execution mode index management circuit 130 is configured to access storage circuit 140 to determine if the given execution mode transition is allowed. If information in storage circuit 140 indicates that the given execution mode transition is allowed, updated execution mode index 118 is written to execution mode index register 150. In some embodiments, before execution mode index register 150 is updated, execution mode index management circuit 130 is configured to write current execution mode index 116 (that is, the value of execution mode index register 150 before the update) to a specified register (e.g., a register specified by execution mode transition indication 106). If, on the other hand, information in storage circuit 140 indicates that the given execution mode transition is not allowed, execution mode index register 150 is not updated. In some embodiments, execution mode index management circuit 130 may generate an exception when a particular execution mode transition is not allowed.

Storage circuit 140 is shown using a dotted line in FIG. 1 to indicate that it is not necessarily located within execution mode index management circuit 130. In some embodiments, storage circuit 140 may be located within execution mode index management circuit 130. In other embodiments, storage circuit 140 may be located elsewhere within processor circuit 110. In still other embodiments, storage circuit 140 may be located external to processor circuit 110. In each of these cases, however, execution mode index management circuit 130 is configured to access storage circuit 140. In one embodiment, execution mode index management circuit 130 is located within an execution unit of an execution pipeline circuit of processor circuit 110.

As depicted, storage circuit 140 includes a first portion that stores privileged execution mode transition information in portion 140A for a first privileged privilege level and a second portion that stores unprivileged execution mode transition information in portion 140B for a first unprivileged privilege level. (More generally, storage circuit 140 stores execution mode transition information for any of two or more privilege levels.) In some embodiments, storage circuit 140 stores transition information for as many privilege levels as exist for processor circuit 110. As will be described, current privilege level 108 is used to select the appropriate portion of transition information within storage circuit 140. In this manner, storage circuit 140 stores different transition information for different privilege levels, which means that a given execution mode transition may be allowable at a first privilege level but not at a second privilege level. Use of current privilege level 108 to select transition information advantageously allows for more granular controls on execution mode transitions, resulting in more granular controls on memory permissions. This paradigm allows configuration of privileged and unprivileged contexts to be independent, such that the computer system kernel can configure its own permissions in a manner orthogonal to how it has configured user space.

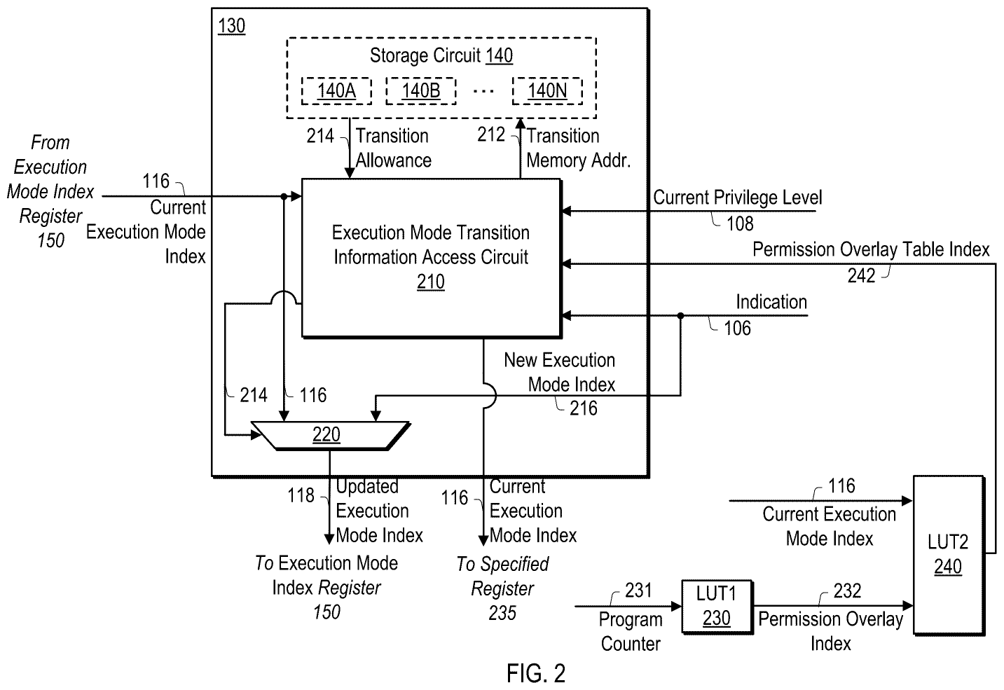

FIG. 2 is a block diagram of one embodiment of an execution mode index management circuit configured to access execution mode transition information. As depicted, execution mode index management circuit 130 includes execution mode transition information access circuit 210 and multiplexer circuit 220. As noted above, storage circuit 140, which includes a plurality of portions 140A-N for different privilege levels, may be located within execution mode index management circuit 130, or external to that circuit.

Execution mode transition information access circuit 210 is configured to generate, based on a number of inputs, transition memory address 212 in order to access appropriate transition allowance 214. In the embodiment shown, transition memory address 212 is generated based on current privilege level 108, permission overlay table index 242, and information included within indication 106. Because storage circuit 140 is organized into portions 140A-N according to privilege level, current privilege level 108 may be used as part of transition memory address 212 to select the appropriate portion of storage circuit 140.

Permission overlay table index 242 is a value indicative of current memory permissions. One example of how permission overlay table index 242 may be computed is shown in FIG. 2. Current program counter (PC) 231 indicates where the current software agent is executing, and can be used as an index into a lookup table (LUT1) 230 to select permission overlay index 232. Permission overlay index 232 is a spatial identifier that is a proxy for “what code is being executed?,” while current execution mode index 116 is temporal identifier that indicates the execution mode of the current software agent that is executing. Stated another way, current execution mode index 116 indicates the current execution mode, while permission overlay index 232 indicates which segment of code/instructions that software component is executing.

In one embodiment, permission overlay index 232 and current execution mode index 116 are concatenated and used to index into another lookup table (LUT2) 240 to select permission overlay table index 242. Permission overlay table index 242, in one embodiment, indicates which set of permissions (or row) in a permissions overlay table (POT) should be used for any current memory accesses, based on both spatial and temporal elements. Permission overlay table index 242 is also used, as shown in FIG. 2, as an input to execution mode transition information access circuit 210 in order to select appropriate transition information from within a selected portion 140A-N of storage circuit 140. Note that permission overlay table index 242 may be computed differently in other embodiments, such as by the concatenation of permission overlay index 232 and current execution mode index 116 (i.e., without the lookup into LUT2 240). In another embodiment, permission overlay table index 242 may simply be the current value of execution mode index register 150. As noted, permission overlay table index 242, generally speaking, is a value indicative of current state or permissions prior to the attempted execution mode transition.

This paradigm permits one page of code, with a given permission overlay index 232, to be executed with two different values of current execution mode index 116, leading to two different values of permission overlay table index 242, and thus two different views of permissions. This paradigm, by concatenating current execution mode index 116 and permission overlay index 23 to address LUT2 240, also allows restricting execution mode transitions to certain pages (i.e., spatially), rather than restricting execution mode transition based only on current execution mode index 116. Thus, an application may be configured such that the vast majority of its code is never allowed to make an execution mode transition. For those portions of code that are allowed to request execution mode transitions, the combination of current execution mode index 116 and permission overlay index 232 is used to determine permission overlay table index 242, which in turn is used as an input into execution mode transition information access circuit 210 in order to determine a permitted set of new values for current execution mode index 116.

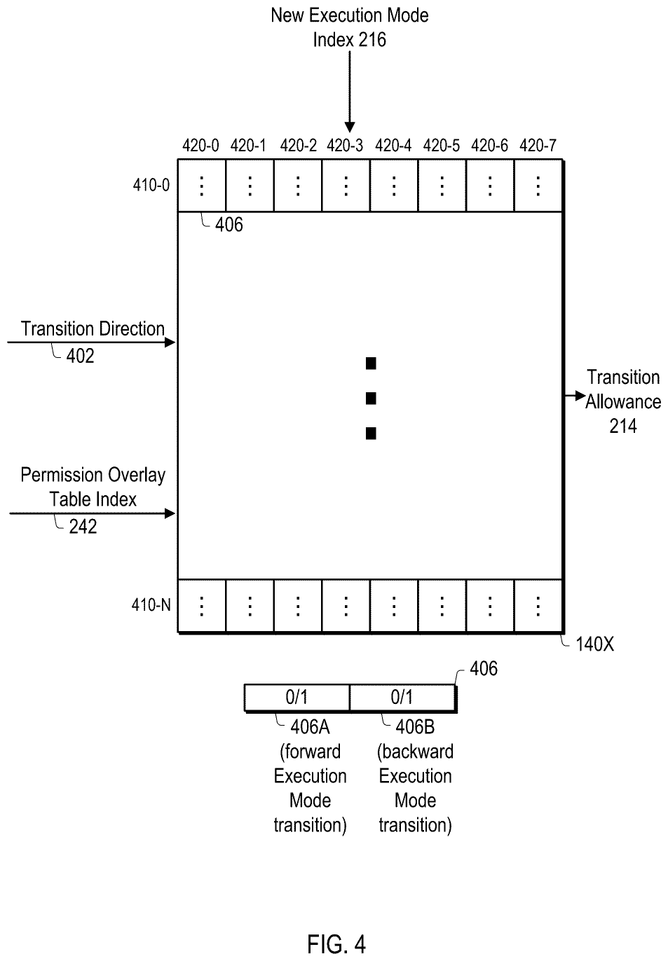

Information within indication 106 may be used to further address storage circuit 140. For example, transition memory address 212 may be formed using a new execution mode index 216 included within indication 106. Then, address 212 may be used along with permission overlay table index 242 to address a portion of storage circuit 140 selected by current privilege level 108. Additional information within indication 106 may also be used to address storage circuit 140 in some embodiments, such as a transition directionality indicator described below with reference to FIG. 4.

Storage circuit 140, in response to being addressed by transition memory address 212, is configured to return transition allowance 214. In one embodiment, allowance 214 is a single bit value indicating whether the execution mode transition is allowed. In other embodiments, additional information may be stored in storage circuit 140, requiring more bits. Such allowance information might be conditional based on other information stored outside storage circuit 140. Transition allowance 214 may be conveyed by execution mode transition information access circuit 210 to act a selection value for multiplexer circuit 220, which receives current execution mode index 116 (from execution mode index register 150 via execution mode transition information access circuit 210 in one embodiment) and new execution mode index 216 as inputs. Multiplexer circuit 220 is configured to pass new execution mode index 216 as updated execution mode index 118 if transition allowance 214 indicates that the execution mode transition is allowed. Conversely, multiplexer circuit 220 is configured to pass current execution mode index 116 as updated execution mode index 118 if transition allowance 214 indicates that the execution mode transition is not allowed. In either event, updated execution mode index 118 is written to execution mode index register 150. In some implementations, execution mode index register 150 may only be updated if a new value is being written.

In some implementations, current execution mode index 116, which may be changed if the execution mode transition is allowed, may be written to a specified register 235. Specified register 235 may be indicated, for example, within indication 106, and may be an architected or special purpose register in various embodiments. The saving of current execution mode index 116 in a known location may be useful, for example, when returning from one software execution mode to another as part of a call/return paradigm.

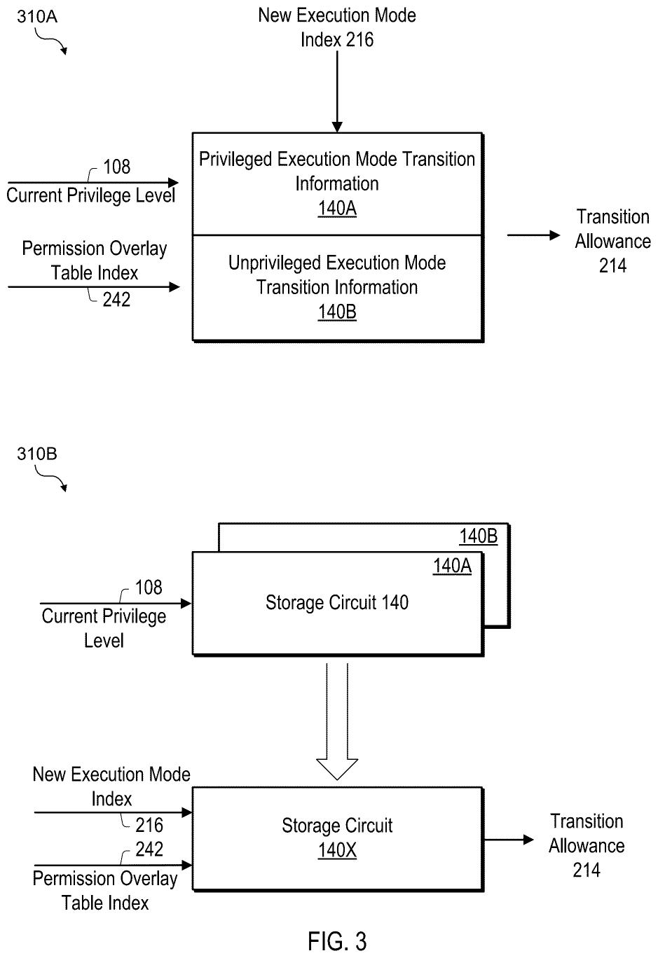

FIG. 3 is a block diagram illustrating two possible configurations 310 of storage circuit 140. Configurations 310A-B both include portions 140A and 140B, where 140A includes privileged execution mode transition information (e.g., allowed/not allowed indications for privileged privilege levels) and 140B includes unprivileged execution mode transition information (e.g., allowed/not allowed indications for unprivileged privilege levels). Although only two portions 140A-B are illustrated for simplicity, it is to be understood that more portions may be included in a given implementation of storage circuit 140.

Simply put, FIG. 3 is intended to illustrate that storage circuit 140 may be organized in a variety of possible ways. Configuration 310A depicts a single-table format, while configuration 310B depicts a multi-table format. In configuration 310A, current privilege level 108, permission overlay table index 242, and new execution mode index 216 may all be used to access a particular set of transition information in order to retrieve transition allowance 214. In one implementation, current privilege level 108 is used to select a group of rows that corresponds to a particular portion of storage circuit 140, while permission overlay table index 242 is used to identify a particular row within the selected portion. New execution mode index 216 can be used to select the column in which transition allowance 214 is stored.

In configuration 310B, storage circuit 140 is organized as a group of separate tables, or alternately as a single three-dimensional table. In this configuration, there can be as many tables as there are privilege levels. Alternatively, the depth of the privilege level “dimension” in a three-dimensional table is sufficient to store transition information for all relevant privilege levels. In either implementation, a particular portion is selected by current privilege level 108. Within the selected portion (denoted as 140X), a particular row is selected using permission overlay table index 242 and a particular column is selected using new execution mode index 216. Of course, rows and columns may be swapped in other implementations.

FIG. 4 is a block diagram of one organization of a portion of two-dimensional storage circuit that includes transition information for a particular privilege level. As depicted, execution mode transition information within portion 140X of storage circuit 140, which has been selected from a plurality of portions using current privilege level 108, is organized into a plurality of rows, denoted as 410-0 to 410-N, and eight columns, denoted as 420-0 to 420-7. The appropriate row is selected using permission overlay table index 242, while the appropriate column is selected using new execution mode index 216.

In one implementation, the transition information stored at the intersection of the selected row and column stores a single bit that is used to indicate whether the requested execution mode transition is allowed. In the depicted implementation, however, transition information 406 stored at the intersection of the selected row and column stores two bits. The first of these bits (406A) is accessed if the execution mode transition is for a forward execution mode transition, and the second of these bits (406B) is accessed if the execution mode transition is for a backward execution mode transition. Other implementations of portion 140X are possible and contemplated.

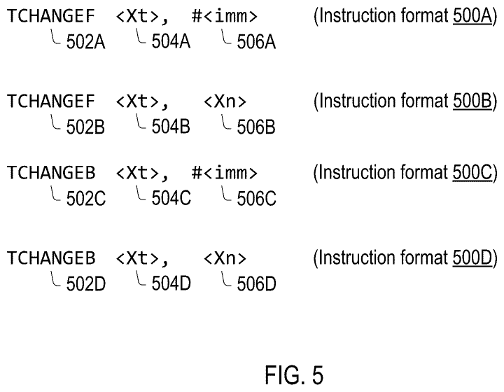

As described above, execution mode index management circuit 130 is configured to attempt to update execution mode index register 150 in response to execution mode transition indication 106. In various embodiments, indication 106 may be an instruction within the ISA of processor circuit 110. FIG. 5 illustrates four exemplary instruction formats (500A-D), where instances of these instructions are executable to perform an execution mode transition. Each of these instructions is associated with a particular directionality. Instruction formats 500A-B are for forward execution mode transitions, while instruction formats 500C-D are for backward execution mode transitions.

Although FIG. 5 depicts ISA instructions, other types of instructions are possible. As used herein, the term “instruction” is intended to broadly cover commands to a processor circuit in a computer program, including without limitation: instruction set architecture (ISA)-defined instructions, interpreted instructions, compiled instructions, microcode, machine code, etc. Still further, the present disclosure contemplates non-instruction-based execution mode transitions, such as those initiated in response to a signal that is asserted based on an interrupt, for example.

An instance of instruction format 500A (“TCHANGEF”) is executable to update the value of the execution mode index, if allowed, and write back the value of the execution mode index (e.g., 116) prior to the update back to a specified register (e.g., 235). The update is permitted if the appropriate location in the execution mode transition memory (e.g., storage circuit 140) allows a change of the execution mode index to the value of the immediate (506A) specified in the instruction, while executing with the current execution mode index (e.g., 116). On the other hand, if the update is not allowed, an exception is generated. The check for allowability is performed using transition information in storage circuit 140 that is specifically for forward execution mode transitions (e.g., 406A).

Instruction format 500A includes opcode 502A (which indicates a forward transition), operand field 504A referencing the 64-bit name of the general-purpose register Xt (235) to be updated with the outgoing execution mode index value, and operand field 506A with a 7-bit unsigned immediate value (“imm7”). During decode, a quantity “target” may be set to the value specified in the imm7 field (corresponding to the new execution mode index), and an integer value t may be established that specifies the number of the general-purpose register being updated.

One example of pseudocode for implementing an instance of an instruction having instruction format 500A is as follows:

```
if Transition_Memory(privilege_level,
permission_overlay_table_index, target, forward) then
  X[t, 64] = ZeroExtend(execution_mode_index, 64);
  execution_mode_index = target;
else
  Exception(target).
```

This pseudocode accesses transition information in storage circuit 140 using current privilege level (to select a portion 140X of storage circuit 140), permission overlay table index 242 (to select a row within the selected portion), and new execution mode index 216 (to select a column within the selected row). Then, the “forward” portion of the selected row/column (e.g., the first of two bits) is checked since opcode 502A indicates that a forward execution mode transition is being attempted. If the accessed bit is set, the specified register Xt receives a zero-extended version of the current value of the execution mode index, and then the execution mode index is set to the target. If the accessed bit is not set, an exception is taken.

Instruction format 500B is similar to instruction format 500A, except that operand field 506B specifies a register value with the new execution mode index, as opposed to an immediate value as in instruction format 500B. Opcode 502B may differ from opcode 502A to indicate a different register format-operands 504A and 504B may be the same. During decode of an instruction having instruction format 500B, the following operations may occur:

$$integer n = UInt ( Rn ) ;$$

$$integer t = UInt ( Rt ) ;$$

$$bits ( 7 ) target = X [ n , 64 ] < 6 : 0 > .$$

Execution of instruction format 500B may then be accomplished using the same pseudocode as with instruction format 500A.

An instance of instruction format 500C (“TCHANGEB”) is executable to update the value of the execution mode index, if allowed, and write back the value of the execution mode index (e.g., 116) prior to the update back to a specified register (e.g., 235). The update is permitted if the appropriate location in transition memory (e.g, 140) allows a change of the execution mode index to the value of the immediate (506C) specified in the instruction, while executing with the current index (e.g, 116). On the other hand, if the update is not allowed, an exception is generated. The check for allowability is performed using transition information in storage circuit 140 that is specifically for backward execution mode transitions.

Instruction format 500C includes opcode 502C (which indicates a backward transition), operand field 504C referencing the 64-bit name of the general-purpose register Xt (235) to be updated with the outgoing execution mode index value, and operand field 506C with a 7-bit unsigned immediate value (“imm7”). During decode, quantity “target” may be set to the value specified in the imm7 field (corresponding to the new execution mode index), and an integer value t may be established that specifies the number of the general-purpose register being updated.

One example of pseudocode for implementing an instance of an instruction having instruction format 500C is as follows:

```
if Transition_Memory(privilege_level,
permission_overlay_table_index, target, backward) then
  X[t, 64] = ZeroExtend(execution_mode_index, 64);
  execution_mode_index = target;
else
  Exception(target).
```

This pseudocode accesses transition information in storage circuit 140 using current privilege level (to select a portion 140X of storage circuit 140), permission overlay table index 242 (to select a row within the selected portion), and new execution mode index 216 (to select a column within the selected row). Then, the “backward” portion of the selected row/column (e.g., the second of two bits) is checked since opcode 502C indicates that a backward execution mode transition is being attempted. If the accessed bit is set, the specified register Xt receives a zero-padded version of the current value of the execution mode index, and then the execution mode index is set to the target. If the accessed bit is not set, an exception is taken.

Instruction format 500D is similar to instruction format 500C (opcode 502D may be different from 502C, while operands 504C-D are the same), except that operand field 506D specifies a register value with the new execution mode index, as opposed to an immediate value as in instruction format 500C. During decode of an instruction having instruction format 500D, the following operations may occur:

$$integer n = UInt ( Rn ) ;$$

$$integer t = UInt ( Rt ) ;$$

$$bits ( 7 ) target = X [ n , 64 ] < 6 : 0 > .$$

Execution of instruction format 500D may then be accomplished using the same pseudocode utilized by instruction format 500C.

Accordingly, FIG. 5 discloses that software may use these instructions to perform execution mode index transitions. Such software may be embodied on a non-transitory (i.e., tangible), computer-readable storage medium storing program instructions that include one or more instances of an instruction that attempts to perform an execution mode transition in which a current value of an execution mode index is changed, within a processor circuit of a computer system, to a new value of the execution mode index. The execution mode index is indicative of a software execution mode that is currently executing on the processor circuit. Execution of a particular instance of the instruction causes the processor circuit to determine transition information indicating whether the execution mode transition to the new value of the execution mode index specified by the particular instance of the instruction is allowed. The transition information is determined based on a current state of the processor circuit (e.g., current privilege level), the new value of the execution mode index, and a directionality of the execution mode transition specified by the particular instance of the instruction. Execution of the instruction further causes the processor circuit, in response to determining, based on the transition information, that the execution mode transition is allowed: to store the current value of the execution mode index to a specified location, and perform an update of the execution mode index to the new value of the execution mode index.

Specific instruction formats for execution mode transition instructions with directionality are contemplated. In one instruction format (500A), an opcode (502A) specifies that the directionality of the execution mode transition is a forward execution mode transition, a first operand value (506A) is an immediate value that specifies the new value of the execution mode index, and a second operand value (504A) specifies a register as the specified location for storing the current value of the execution mode index prior to the update. In another instruction format for forward execution mode transitions (500B), an opcode (502B) specifies that the directionality of the execution mode transition is a forward execution mode transition, a first operand value (506B) specifies a first register that stores the new value of the execution mode index, and a second operand value (504B) that indicates a second register as the specified location for storing the current value of the execution mode index prior to the update.

Instruction formats for backward execution mode transitions are also contemplated. In one instruction format (500C), an opcode (502C) specifies that the directionality of the execution mode transition is a backward execution mode transition, a first operand value (506C) is an immediate value that specifies the new value of the execution mode index, and a second operand value (504C) indicates a register as the specified location for storing the current value of the execution mode index prior to the update. In another instruction format (500D), an opcode (502D) specifies that the directionality of the execution mode transition is a backward execution mode transition, a first operand value (506D) specifies a first register that stores the new value of the execution mode index, and a second operand value (504D) specifies a second register as the specified location for storing the current value of the execution mode index prior to the update.

As has been described, execution mode index management circuit is configured to attempt to update execution mode index register 150 if allowed. As indicated in FIG. 1, the value of execution mode index register 150 may be utilized by permission circuit 120 to compute memory permissions. FIG. 6 is a block diagram of one possible implementation of a permission circuit 120 that is configured to evaluate permissions for a particular instruction 605 based on a current value of execution mode index register 150. As shown, permission circuit 120 includes context permissions table(s) 610, region permission table(s) 620, and permissions operation table 630.

Permission circuit 120 is, in one embodiment, configured to determine permissions based on instruction information 102 describing both the source and destination of instruction 605. Instruction information 102 is intended to refer to any information related to instruction 605, including operand values and the state of processor circuit 110 at the time of execution of instruction 605. Note that the instruction 605, in this example, is a memory-accessing instruction (e.g., a load-store instruction or a branch instruction), and not an execution mode transition instruction.

As shown, instruction information 102 includes information describing both the source and the destination of instruction 605. Source information 102A, which may correspond to a program counter of instruction 605, may be used to index into context permissions table 610, along with current execution mode index 116 to obtain a first set of permissions 615, which may correspond to a temporal set of permissions in one embodiment. Destination information 102B may correspond to a virtual address of a location accessed by instruction 605 in one embodiment. Destination information 102B is used to index into region permission table 620 to obtain a second set of permissions 625. Permissions 625 may constitute a set of spatial permissions in one embodiment. Together, first set of permissions 615 and second set of permissions 625 can be used to index into yet another table, permissions operation table 630, in order to determine a final set of permissions, referred to as instruction permission information 104. Instruction permission information 104 can be used to determine read/write/execute permissions for instruction 605.

To recap, the present disclosure has also described an apparatus in which different types of execution mode transition instructions are supported, such that different transition information may be specifically stored for different instruction types. Such an apparatus, with reference to exemplary reference numerals, may include a computer system (100), a processor circuit (110), a memory permissions circuit (120), an execution mode index management circuit (130), storage circuit (140), execution mode transition information (140A-B), and an execution mode index register (150).

A processor circuit (110) is configured to execute instructions at a plurality of privilege levels. The processor circuit includes an execution mode index management circuit (130) configured to 1) receive, while a current software agent is executing at a current privilege level, an indication of an execution mode transition that attempts to change an execution mode index from a current value indicative of a current execution mode to a new value indicative of a new execution mode, 2) access, based on the current privilege level, particular execution mode transition information in storage circuit (140) to determine whether the execution mode transition is allowed, 3) determine, based on the particular execution mode transition information, whether to update the current value of the current execution mode, and 4) update the current value indicative of the execution mode based on a determination that the execution mode transition is permitted. The processor circuit may also include, in some embodiments, a memory permission circuit (120) configured to determine, based on the current value of the execution mode index, memory permissions for memory-accessing instructions being executed by the processor circuit.

In some implementations, the indication is an instance of a particular execution mode transition instruction, where the instance of the particular execution mode transition instruction specifies a new execution mode index for the new execution mode, and where the execution mode index management circuit is configured to execute the instance of the particular execution mode transition instruction. The instance of the particular execution mode transition instruction may correspond to a particular directionality of the execution mode transition. Accordingly, the execution mode index management circuit may be configured to perform a first type of execution mode transition instruction to perform the execution mode transition in a forward direction and a second type of execution mode transition instruction to perform the execution mode transition in a backward direction.

The instruction may have various implementations. In one embodiment, the instance of the particular execution mode transition instruction specifies the new execution mode index using an immediate value, and where, to execute the particular execution mode transition instruction, the execution mode index management circuit is configured to use the immediate value to access the storage circuit in order to obtain the particular execution mode transition information. In another embodiment, the instance of the particular execution mode transition instruction specifies a first register of the processor circuit as an input operand, and where, to execute the particular execution mode transition instruction, the execution mode index management circuit is configured to use a value stored in the first register to access the storage circuit in order to obtain the particular execution mode transition information, the value stored in the first register being indicative of the new execution mode index. In yet another embodiment, the instance of the particular execution mode transition instruction specifies a particular register as an output operand, and where, to execute the particular execution mode transition instruction, the execution mode index management circuit is configured to write the current value of the execution mode index to the particular register.

In one embodiment, the storage circuit with transition information is accessed using a 1) permission overlay table index indicative of a set of memory permissions for a) a current program counter of the processor circuit and b) the current execution mode, and 2) the new execution mode index. In some implementations, the storage circuit with transition information may include a plurality of two-dimensional tables, where a given two-dimensional table corresponds to a particular one of the plurality of privilege levels and is accessed using the permission overlay index and the new execution mode index.

In some cases, the execution mode transition may not be allowed. In such scenarios, the execution mode index management circuit may generate an exception.

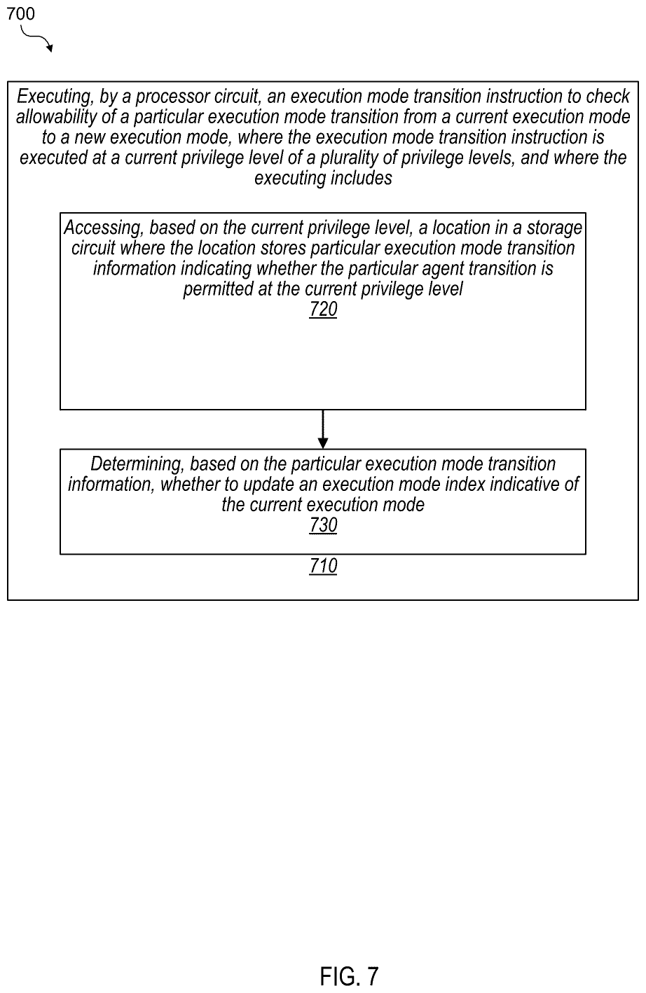

FIG. 7 is a flow diagram of one embodiment of a method 700 for executing execution mode transition instructions. In one embodiment, method 700 is performed by a processor such as processor circuit 110.

Method 700 commences in 710, in which a processor circuit (e.g., processor circuit 110) of a computer system (one example of apparatus 100) executes an execution mode transition instruction to check allowability of a particular execution mode transition from a current execution mode to a new execution mode, where the execution mode transition instruction is executed at a current privilege level of a plurality of privilege levels.

In 720, which is a sub-step of 710, the processor accesses, based on a current privilege level, a location in a storage circuit storing execution mode transition information (e.g., storage circuit 140), and where the location stores particular execution mode transition information indicating whether the particular execution mode transition is permitted at the current privilege level. The storage circuit may store, for example, first execution mode transition information (e.g., information 140A) for the unprivileged privileged level and second execution mode transition information (e.g., information 140B) for the privileged privilege level

Next, in 730, which is also a sub-step of 710, the processor determines, based on the particular execution mode transition information, whether to update an execution mode index indicative of the current software execution mode.

In some embodiments of method 700, the processor sets, using the execution mode index, memory permissions for subsequent instructions in program order after the execution mode transition instruction.

The execution mode transition information may differ based on the directionality of the instruction. For example, the first execution mode transition information includes a first set of information specifying allowable execution mode transitions in a forward direction and a second set of information specifying allowable execution mode transitions in a backward direction and where the location is accessed from the first set of information based on the execution mode transition instruction specifying a forward execution mode transition. As another example, the first execution mode transition information includes a first set of information specifying allowable execution mode transitions in a forward direction and a second set of information specifying allowable execution mode transitions in a backward direction and where the location is accessed from the second set of information based on the execution mode transition instruction specifying a backward execution mode transition.

If the circuit determines that the transmission is allowed, the executing may further include storing, to a specified register, a current value of the execution mode index that is indicative of the current execution mode, and updating the execution mode index with a new value indicative of the new execution mode. The accessing may be further based on a permission overlay index indicative of a set of memory permissions for 1) a current program counter of the processor circuit and 2) the current execution mode, and a new value indicative of the new execution mode.

### Example Device

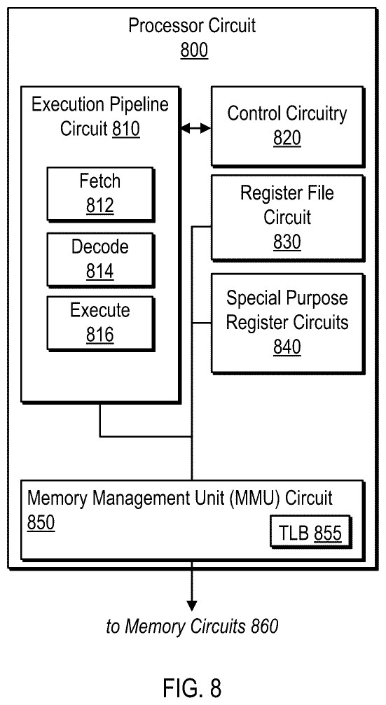

FIG. 8 is a block diagram of one embodiment of a processor circuit that may be implemented on one or more integrated circuits (ICs). As depicted, processor circuit 800 includes execution pipeline circuit 810, control circuitry 820, register file circuit 830, special purpose register circuits 840, and memory management unit (MMU) circuit 850. Processor circuit 800 is configured to perform instructions included in any suitable instruction set architecture (ISA). For example, processor circuit 800 may be configured to perform instructions included in ARM's Arm V9 ISA. In some embodiments, processor circuit 800 may be configured to perform execution mode transition instructions such as 500A-D described above. Processor circuit 800 is one possible instance of previously described processor circuit 110.

Execution pipeline circuit 810 is representative of circuitry within processor circuit 800 designed to retrieve instructions from memory, and then decode and execute them. Execution pipeline circuit 810 may include any number of stages, but only three exemplary stages are illustrated in FIG. 8. Fetch stage circuit 812, in one embodiment, is configured to issue memory requests to retrieve instructions. In some embodiments, fetch stage circuit 812 may include pre-fetch circuitry to issue memory requests based on predicted next-fetch addresses. Instructions received via the issued memory requests may be stored in an instruction cache (not pictured) within processor circuit 800. Decode stage circuit 814, in one embodiment, is configured to parse instructions received by fetch stage circuit 812 in order to perform decode operations that prepare the instructions to be processed by execute stage circuit 816. For example, decode stage circuit 814 may be configured to determine, from a retrieved instruction, a type of the instruction, a number of its operands, and whether data corresponding to the operands is currently available within processor circuit 800. Decode stage circuit 814 may be configured to place decoded, ready-to-execute instructions in an instruction buffer (not shown) for access by execute stage circuit 816. Execute stage circuit 816, in one embodiment, may retrieve a ready-to-execute instruction from an instruction buffer and perform the instruction using any associated operands. “Performing” the instructions may constitute different actions depending on the type of instruction. Some execution unit circuits within execute stage circuit might be able to totally complete the instructions, such as in the case of a register operation. Other execution units might initiate execution of an instruction, such as a load-store instruction in which a portion of the memory hierarchy is accessed. Operands of the instruction that reference memory locations may thus be loaded as part of execution by a load-store execution unit circuit, and stored in a data cache (not pictured). One possible execution unit circuit may be configured to perform execution mode transition instructions such as those described herein.

In various embodiments, execute stage circuit 816 may perform instructions in a same order as the instructions were fetched (e.g., in-order processing) or may be capable of changing an order of the instructions to improve processor efficiency (e.g., out-of-order processing). Although execute stage circuit 816 is shown as a single block, in some embodiments, execute stage circuit 816 may include a plurality of execution units, such as an integer/Boolean unit, a floating-point unit, a load-store unit, and the like. Execution pipeline circuit 810 may be configured to process one program thread at a time or multiple threads in an overlapping (e.g., time-sliced) manner.

Control circuitry 820 is configured to perform various processor control operations related to execution of instructions using execution pipeline circuit 810. These control operations include exception handling, context switches, packet transmission, etc. For example, control circuitry 820 may be configured to generate an exception based on a variety of inputs (such as an execution mode transition not being allowed).

Register file circuit 830 includes a set of registers that may be used to store operands for various instructions of execution pipeline circuit 810. Such registers are commonly called “general purpose registers,” or GPRs. Register file circuit 830 may include registers of various data types, based on the type of operand that execution pipeline circuit 810 is configured to store in the registers (e.g., integer, floating point, multimedia, vector, etc.). Register file circuit 830 may directly implement architectural registers or may implement rename circuitry to map architectural registers to physical registers.

Special purpose register circuits 840, in one embodiment, are registers within processor circuit 800 that are configured to store specific types of values. These special purpose register circuits 840 stand in contrast to registers of register file circuit 830, which may be used by any instruction executing on processor circuit 800. Execution mode index register 150, for example, may be implemented as part of special purpose register circuit 840, as it is used for the specific purpose of storing execution mode index data. Examples of special purpose register circuits 840 include the program counter (PC), instruction register (IR), stack pointer (SP), status register (flags register), and various other control registers.

MMU circuit 850 is configured to act as an interface between processor circuit 800 and memory located on memory circuit 860. For example, MMU circuit 850 may issue memory requests to a memory hierarchy that includes memory circuit 860. In one embodiment, MMU circuit 850 is coupled to a memory bus interface to perform read and write operations with memory circuit 860, including retrieving instructions and other information and storing information related to execution of program threads performed by execution pipeline circuit 810.

Furthermore, MMU circuit 850 may receive memory requests from execute stage circuit 816 (e.g., from a load-store unit circuit) and fetch stage circuit 812. In some embodiments, MMU circuit 850 may be coupled to a plurality of execution pipeline circuits, such as may be included in a core complex. Note that additional memory (not pictured) may be located on processor circuit 800. Note that MMU circuit 850 is commonly configured to receive memory requests that specify virtual addresses. In such embodiments, MMU circuit 850 may be configured to use translation lookaside buffer (TLB) 855 to cache translation information to translate a received virtual address into a physical address corresponding to a particular location in memory circuit 860. Notably, MMU circuit 850 may also be configured to evaluate and enforce permissions related to various instructions in execution pipeline circuit 810, and may thus include execution mode index management circuit 130 and permission circuit 120 in some embodiments. In one example implementation, MMU circuit 850 may deny a particular memory request if corresponding permissions are not enabled for a received virtual address specified by a memory-accessing instruction.

Memory circuit 860 includes one or more memory circuits within a system memory coupled to processor circuit 800. Although illustrated as a single block, memory circuit 860 may include a plurality of memory blocks. Such blocks may include various types of memory including, but not limited to, dynamic random-access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR2, etc.), RAMBUS

DRAM (RDRAM), static RAM (SRAM), etc. In some embodiments, memory circuit 860 may include non-volatile memory such as flash memory, ferroelectric random-access memory (FRAM), or magnetoresistive RAM (MRAM). One or more memory devices may be coupled onto a circuit board to form memory modules such as single inline memory modules (SIMMs), dual inline memory modules (DIMMs), etc. Alternatively, the devices may be mounted with an SoC or an integrated circuit in a chip-on-chip configuration, a package-on-package configuration, or a multi-chip module configuration.

In some embodiments, the elements of processor circuit 800 shown in FIG. 8 may constitute a single processor core. In other embodiments, the depicted elements constitute one of multiple processor cores within processor circuit 800. In still other embodiments, the depicted circuitry may be part of a one or multiple core complexes, with each complex including a plurality of cores sharing support circuitry such as cache and/or branch prediction circuits (not illustrated).

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages.

Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112 (f) for that claim element. Should Applicant wish to invoke Section 112 (f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom-designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
a processor circuit configured to execute instructions at a plurality of privilege levels, wherein the processor circuit includes:
an execution mode management circuit configured to:
receive an indication of an execution mode transition that attempts to change an execution mode index from a current value indicative of a current execution mode to a new value indicative of a new execution mode;
access, based on a current privilege level, particular execution mode transition information in a storage circuit to determine whether the execution mode transition is allowed;
determine, based on the particular execution mode transition information, whether to update the current value indicative of the current execution mode; and
update the current value indicative of the current execution mode based on a determination that the execution mode transition is permitted.

2. The apparatus of claim 1, wherein the indication is an instance of a particular execution mode transition instruction, wherein the instance of the particular execution mode transition instruction specifies a new execution mode index for the new execution mode, and wherein the execution mode management circuit is configured to execute the instance of the particular execution mode transition instruction.

3. The apparatus of claim 2, wherein the execution mode management circuit is configured to perform a first type of execution mode transition instruction to perform the execution mode transition in a forward direction and a second type of execution mode transition instruction to perform the execution mode transition in a backward direction.

4. The apparatus of claim 2, wherein the instance of the particular execution mode transition instruction corresponds to a particular directionality of the execution mode transition.

5. The apparatus of claim 4, wherein the instance of the particular execution mode transition instruction specifies the new execution mode index using an immediate value, and wherein, to execute the particular execution mode transition instruction, the execution mode management circuit is configured to use the immediate value to access the storage circuit in order to obtain the particular execution mode transition information.

6. The apparatus of claim 4, wherein the instance of the particular execution mode transition instruction specifies a first register of the processor circuit as an input operand, and wherein, to execute the particular execution mode transition instruction, the execution mode management circuit is configured to use a value stored in the first register to access the storage circuit in order to obtain the particular execution mode transition information, the value stored in the first register being indicative of the new execution mode index.

7. The apparatus of claim 4, wherein the instance of the particular execution mode transition instruction specifies a particular register as an output operand, and wherein, to execute the particular execution mode transition instruction, the execution mode management circuit is configured to write the current value of the execution mode index to the particular register.

8. The apparatus of claim 4, wherein the storage circuit is accessed using:
a permission overlay table index indicative of a set of memory permissions for 1) a current program counter of the processor circuit and 2) the current execution mode; and
the new execution mode index.

9. The apparatus of claim 8, the storage circuit includes a plurality of two-dimensional tables, wherein a given two-dimensional table corresponds to a particular one of the plurality of privilege levels and is accessed using the permission overlay table index and the new execution mode index.

10. The apparatus of claim 2, wherein, to execute the particular execution mode transition instruction, the execution mode management circuit is configured to generate an exception based on the execution mode transition not being allowed, and wherein the apparatus further comprises:
a memory permission circuit configured to determine, based on the current value indicative of the current execution mode, memory permissions for memory-accessing instructions being executed by the processor circuit.

11. A method, comprising:
executing, by a processor circuit, an execution mode transition instruction to check allowability of a particular execution mode transition from a current execution mode to a new execution mode, wherein the execution mode transition instruction is executed at a current privilege level of a plurality of privilege levels, and wherein the executing includes:
accessing, based on the current privilege level, a location in a storage circuit, wherein the location stores particular execution mode transition information indicating whether the particular execution mode transition is permitted at the current privilege level; and
determining, based on the particular execution mode transition information, whether to update an execution mode index indicative of the current execution mode.

12. The method of claim 11, wherein the storage circuit stores a first set of information specifying allowable execution mode transitions in a forward direction and a second set of information specifying allowable execution mode transitions in a backward direction and wherein the location is accessed from the first set of information based on the execution mode transition instruction specifying a forward execution mode transition.

13. The method of claim 11, wherein the storage circuit stores a first set of information specifying allowable execution mode transitions in a forward direction and a second set of information specifying allowable execution mode transitions in a backward direction and wherein the location is accessed from the second set of information based on the execution mode transition instruction specifying a backward execution mode transition.

14. The method of claim 11, wherein an opcode of the execution mode transition instruction is associated with a direction of the particular execution mode transition, and wherein, based on determining to update the execution mode index, the executing further includes:
storing, to a specified register, a current value of the execution mode index that is indicative of the current execution mode; and
updating the execution mode index with a new value indicative of the new execution mode.

15. The method of claim 14, wherein accessing the location is also based on:
a permission overlay index indicative of a set of memory permissions for 1) a current program counter of the processor circuit and 2) the current execution mode; and
a new value indicative of the new execution mode.

16. A non-transitory, computer-readable storage medium storing program instructions that include one or more instances of an instruction that is executable by a processor circuit of a computer system to attempt to perform an execution mode transition in which a current value of an execution mode index is changed to a new value, a value of the execution mode index being indicative of a current execution mode of the processor circuit, wherein execution of a particular instance of the instruction causes the processor circuit to:
determine transition information indicating whether the execution mode transition to the new value of the execution mode index specified by the particular instance of the instruction is allowed, wherein the transition information is determined based on a current privilege level of the processor circuit, the new value of the execution mode index, and a directionality of the execution mode transition specified by the particular instance of the instruction;
in response to the transition information indicating that the execution mode transition is allowed:
store the current value of the execution mode index to a specified location; and
perform an update of the execution mode index to the new value of the execution mode index.

17. The non-transitory, computer-readable storage medium of claim 16, wherein the particular instance of the instruction includes an opcode, a first operand value, and a second operand value, and wherein:
the opcode specifies that the directionality of the execution mode transition is a forward execution mode transition;
the first operand value is an immediate value that specifies the new value of the execution mode index; and
the second operand value specifies a register as the specified location for storing the current value of the execution mode index prior to the update.

18. The non-transitory, computer-readable storage medium of claim 16, wherein the particular instance of the instruction includes an opcode, a first operand value, and a second operand value, wherein:
the opcode specifies that the directionality of the execution mode transition is a forward execution mode transition;
the first operand value specifies a first register that stores the new value of the execution mode index; and
the second operand value specifies a second register as the specified location for storing the current value of the execution mode index prior to the update.

19. The non-transitory, computer-readable storage medium of claim 16, wherein the particular instance of the instruction includes an opcode, a first operand value, and a second operand value, wherein:
the opcode specifies that the directionality of the execution mode transition is a backward execution mode transition;
the first operand value is an immediate value that specifies the new value of the execution mode index; and
the second operand value specifies a register as the specified location for storing the current value of the execution mode index prior to the update.

20. The non-transitory, computer-readable storage medium of claim 16, wherein the particular instance of the instruction includes an opcode, a first operand value, and a second operand value, wherein:
the opcode specifies that the directionality of the execution mode transition is a backward execution mode transition;
the first operand value specifies a first register that stores the new value of the execution mode index; and
the second operand value specifies a second register as the specified location for storing the current value of the execution mode index prior to the update.
